(19) United States
(12) Patent Application Publication
(10) Pub. No.: US 2026/0109007 A1
(43) Pub. Date: Apr. 23, 2026

(54) Nut Driver Tool With Front Loading Flip Socket Storage

(71) Applicant: Klein Tools, Inc., Lincolnshire, IL (US)

(72) Inventors: Stephen Powers, Grand Prairie, TX (US); Jordan L. Fisher, Mansfield, TX (US); Kevin Basler, Euless, TX (US)

(73) Assignee: Klein Tools, Inc., Lincolnshire, IL (US)

(21) Appl. No.: 19/315,527

(22) Filed: Aug. 30, 2025

Related U.S. Application Data
(60) Provisional application No. 63/689,216, filed on Aug. 30, 2024.

(51) Int. Cl. B25B 13/06; B25B 23/00

(52) U.S. Cl. CPC B25B 13/065; B25B 23/0035

(57) ABSTRACT

A nut driving tool capable of mounting multiple sockets on a shank, including at least one socket in a use position on a socket mounting end of the shank and another socket in a storage position, with the socket in the storage position movable from the storage position past as socket mounting end of the shank.

### CROSS-REFERENCE TO RELATED APPLICATIONS

This application claims the benefit of U.S. Provisional Patent Application Ser. No. 63/689,216 filed Aug. 30, 2024, titled Nut Driver Tool With Front Loading Flip Socket Storage, the entire disclosure of which is incorporated herein by reference.

### BACKGROUND OF THE DISCLOSURE

The present disclosure relates nut drivers, and more specifically to nut drivers that utilize a reversible socket. Such nut drivers are known and include nut drivers that utilize a drive shank that can receive a reversible socket in either a first orientation or a second orientation, with each orientation of the reversible socket providing a different socket size than the other orientation. It is also known for such drivers to allow the reversible socket to be mounted at two different positions along the length of the drive shank in at least one of the first or second orientations to allow the socket to drive a nut in one of the positions along the length and to receive a drive bit in the other of the positions along the length. It is also known to mount additional sockets on the drive shank with a reversible socket mounted on the end of the shank in a ready to use position. While such known drivers are suitable for their intended purpose, there is always room for improvement, especially with respect to simplicity, reliability, and/or cost to manufacture and assemble. For example, the currently known drivers do not allow for sockets stored on the shank to be easily removed from the shank with the shank mounted in a driver.

### BRIEF SUMMARY OF THE DISCLOSURE

The following are examples of features/structures that could be claimed as inventive concepts.
1. A nut driver tool comprising:
   an elongate drive shank including:
   a socket-mounting end opposite a driver engagement end; and
   a pair of socket stop surfaces facing the socket-mounting end and spaced from the socket-mounting end, the socket stop surfaces spaced from each other by an angular distance; and
      a reversible socket including:
   a first end opposite a second end;
   a first hex socket opening in the first end and sized to engage a hexagonal profile of a first size;
   a second hex socket opening in the second end and sized to engage a hexagonal profile of a second size larger than the first size, the second hex socket facing in an opposite direction from the first hex socket opening;
   a through opening connecting the first and second hex socket openings,
   a pair of first stop surfaces facing the first end, the first stop surfaces spaced from each other by the angular distance;
   a pair of first channels, each of the first channels extending from the first end to a corresponding one of the first stop surfaces, the first channels spaced from each other by the angular distance;
   a pair of second stop surfaces facing the second end, the second stop surfaces spaced from each other by the angular distance;
   a pair of second channels, each second channel extending from the second end to a corresponding one of the second stop surfaces, the second channels spaced from each other by the angular distance; and
   a pair of third channels, each third channel extending from the first end to the second end and spaced circumstantially from the first and second channels, the third channels spaced from each other by the angular distance; and
   wherein:
      the first channels are sized to allow the socket stop surfaces to translate within the first channels from the first end to engage against the first stop surfaces to mount the reversible socket on the socket-mounting end in a first position wherein the drive shank extends through the first hex socket opening with the socket-mounting end spaced from the second end by a first predetermined distance;
      the second channels are sized to allow the socket stop surfaces to translate within the second channels from the second end to engage against the second stop surfaces to mount the reversible socket on the socket-mounting end in a second position wherein the drive shank extends through the second hex socket opening with the socket-mounting end spaced from the first end by a second predetermined distance; and
   the third channels are sized to allow the socket stop surfaces to translate within the third channels to allow the reversible socket to be translated past the socket-mounting end from a stored position on the shank located between the socket-mounting end and the driver engagement end.
2. The tool of claim 1 wherein:
   the drive shank further comprises a detent located on the socket-mounting; and
   the reversible socket further comprises:
   a first detent engagement feature located between the first end and the pair of first stop surfaces, the first detent engagement feature being configured to engage the detent with the socket in the first position; and
   a second detent engagement feature located between the second end and the pair of second stop surfaces, the second detent engagement feature being configured to engage the detent with the socket in the second position.
3. The tool of claim 1 wherein the reversible socket further comprises
   a pair of second additional stop surfaces facing the second end, the second additional stop surfaces spaced from each other by the angular distance; and
   a pair of second additional channels, each second additional channel extending from the second end to a corresponding one of the second additional stop surfaces, the second additional channels spaced from each other by the angular distance; and wherein
   the second additional channels are sized to allow the socket stop surfaces to translate within the second additional channels from the second end to engage against the second additional stop surfaces to mount the reversible socket on the socket-mounting end in a second additional position wherein the drive shank extends through the second hex socket opening with the socket-mounting end spaced from the first end by a second additional predetermined distance.
4. The tool of claim 3 wherein the second predetermined distance and the second additional predetermined distance are equal.
5. The tool of claim 3 wherein the second additional predetermined distance is greater than the second predetermined distance.
6. The tool of claim 5 wherein the second additional predetermined distance is at least twice the second predetermined distance.
7. The tool of claim 3 wherein the reversible socket further comprises:
   a pair of first additional stop surfaces facing the first end, the first additional stop surfaces spaced from each other by the angular distance; and
   a pair of first additional channels, each first additional channel extending from the first end to a corresponding one of the additional stop surfaces, the first additional channels spaced from each other by the angular distance; and wherein
   the first additional channels are sized to allow the socket stop surfaces to translate within the first additional channels from the first end to engage against the first additional stop surfaces to mount the reversible socket on the socket-mounting end in a first additional position wherein the drive shank extends through the first hex socket opening with the socket-mounting end spaced from the second end by a first additional predetermined distance; and
   the first predetermined distance and the first additional predetermined distance are equal.
8. The tool of claim 3 wherein:
   the drive shank further comprises a detent located on the socket-mounting end; and
   the reversible socket further comprises:
   a first detent engagement feature located between the first end and the pair of first stop surfaces, the first detent engagement feature being configured to engage the detent with the socket in the first position;
   a second detent engagement feature located between the second end and the pair of second stop surfaces, the second detent engagement feature being configured to engage the detent with the socket in the second position; and
   a second additional detent engagement feature located between the second end and the pair of second additional stop surfaces, the second additional detent engagement feature being configured to engage the detent with the socket in the second additional position.
9. The tool of claim 8 wherein the second predetermined distance and the second additional predetermined distance are equal.
10.The tool of claim 9 wherein the second additional predetermined distance is greater than the second predetermined distance.
11.The tool of claim 10 wherein the second additional predetermined distance is at least twice the second predetermined distance.
12.The tool of claim 1 wherein:
   the through opening has a hexagonal shaped cross-section sized to engage a hexagonal profile; and
   the shank has a socket engagement portion extending over a length of the socket-mounting end, the socket engagement portion having a hexagonal profile sized to engage the hexagonal profile of the through opening.
13.The tool of claim 12 wherein the shank has a driver engagement portion extending over a length of the driver engagement end, the driver engagement portion having a hexagonal profile of the same size as the socket engagement portion.
14.The tool of claim 1 wherein the shank includes a pair of elongated ribs, each rib having an end that defines one of the socket stop surfaces.
15.The tool of claim 14 wherein each of the ribs extends along an intersection of two planar surfaces of the shank and the angular distance equals 180 degrees.
16. A nut driver tool comprising:
   an elongate drive shank including:
a socket-mounting end opposite a driver engagement end; and
a pair of socket stop surfaces facing the socket-mounting end and spaced from the socket-mounting end, the socket stop surfaces spaced from each other by an angular distance; and
   at least two reversible sockets, each reversible socket including:
a first end opposite a second end;
a first hex socket opening in the first end and sized to engage a hexagonal profile of a first size;
a second hex socket opening in the second end and sized to engage a hexagonal profile of a second size larger than the first size, the second hex socket facing in an opposite direction from the first hex socket opening;
a through opening connecting the first and second hex socket openings,
a pair of first stop surfaces facing the first end, the first stop surfaces spaced from each other by the angular distance;
a pair of first channels, each of the first channels extending from the first end to a corresponding one of the first stop surfaces, the first channels spaced from each other by the angular distance;
a pair of second stop surfaces facing the second end, the second stop surfaces spaced from each other by the angular distance;
a pair of second channels, each second channel extending from the second end to a corresponding one of the second stop surfaces, the second channels spaced from each other by the angular distance; and
a pair of third channels, each third channel extending from the first end to the second end and spaced circumstantially from the first and second channels, the third channels spaced from each other by the angular distance; and
wherein:
   the first channels are sized to allow the socket stop surfaces to translate within the first channels from the first end to engage against the first stop surfaces to mount the reversible socket on the socket-mounting end in a first position wherein the drive shank extends through the first hex socket opening with the socket-mounting end spaced from the second end by a first predetermined distance;
   the second channels are sized to allow the socket stop surfaces to translate within the second channels from the second end to engage against the second stop surfaces to mount the reversible socket on the socket-mounting end in a second position wherein the drive shank extends through the second hex socket opening with the socket-mounting end spaced from the first end by a second predetermined distance; and
the third channels are sized to allow the socket stop surfaces to translate within the third channels to allow the reversible socket to be translated past the socket-mounting end from a stored position on the shank located between the socket-mounting end and the driver engagement end.
17.The nut driver tool of claim 16 wherein each of the hex socket openings is sized to engage a hexagonal profile of a size that is different than any of the other hex socket openings.
18.The tool of claim 17 wherein each of the reversible sockets further comprises:
   a pair of first additional stop surfaces facing the first end, the first additional stop surfaces spaced from each other by the angular distance;
   a pair of first additional channels, each first additional channel extending from the first end to a corresponding one of the additional stop surfaces, the first additional channels spaced from each other by the angular distance;
   a pair of second additional stop surfaces facing the second end, the second additional stop surfaces spaced from each other by the angular distance; and
   a pair of second additional channels, each second additional channel extending from the second end to a corresponding one of the second additional stop surfaces, the second additional channels spaced from each other by the angular distance; and wherein
   the first additional channels are sized to allow the socket stop surfaces to translate within the first additional channels from the first end to engage against the first additional stop surfaces to mount the reversible socket on the socket-mounting end in a first additional position wherein the drive shank extends through the first hex socket opening with the socket-mounting end spaced from the second end by a first additional predetermined distance; and
   the second additional channels are sized to allow the socket stop surfaces to translate within the second additional channels from the second end to engage against the second additional stop surfaces to mount the reversible socket on the socket-mounting end in a second additional position wherein the drive shank extends through the second hex socket opening with the socket-mounting end spaced from the first end by a second additional predetermined distance.
19.The tool of claim 18 where, for at least one of the reversible sockets, the first predetermined distance and the first additional predetermined distance are equal, and the second predetermined distance and the second additional predetermined distance are equal.
20. The tool of claim 16 wherein at least one of the reversible sockets further comprises:
   a pair of second additional stop surfaces facing the second end, the second additional stop surfaces spaced from each other by the angular distance; and
   a pair of second additional channels, each second additional channel extending from the second end to a corresponding one of the second additional stop surfaces, the second additional channels spaced from each other by the angular distance; and wherein
   the second additional channels are sized to allow the socket stop surfaces to translate within the second additional channels from the second end to engage against the second additional stop surfaces to mount the reversible socket on the socket-mounting end in a second additional position wherein the drive shank extends through the second hex socket opening with the socket-mounting end spaced from the first end by a second additional predetermined distance; and
   the second additional predetermined distance is greater than the second predetermined distance.

It should be understood that the inventive concepts disclosed herein do not require each of the features discussed above, may include any combination of the features discussed, and may include features not specifically discussed above.

### BRIEF SUMMARY OF THE SEVERAL VIEWS OF THE DRAWINGS

FIG. 1 is a side view of a nut driver tool according to this disclosure;

FIG. 2 is a perspective view from the front and above of a drive shank of the nut driver tool of FIG. 1;

FIG. 3 is a perspective view from the rear and above of the of the nut driver tool of FIG. 1;

FIG. 4 is a perspective view from the front and above of the nut driver tool of FIG. 1;

FIG. 5 is an end view of a reversible socket of the nut driver tool of FIGS. 1 and 4;

FIG. 6 is an end view of the reversible socket of FIG. 5, but showing the end opposite of FIG. 5;

FIG. 7 is a section view taken from line 7-7 in FIG. 5 showing the reversible socket in a pass-through orientation on the drive shank of FIGS. 1 and 2, with the drive shank not shown in section;

FIG. 8A is a section view taken from line 8-8 in FIG. 5 showing the reversible socket in a nut setting orientation and position on the drive shank of FIGS. 1 and 2, but reversed (flipped) from the orientation shown in FIG. 1;

FIG. 8B is a section view taken from line 8-8 in FIG. 5 showing the reversible socket in another nut setting orientation and position on the drive shank of FIGS. 1 and 2, but reversed (flipped) from the orientation shown in FIG. 8A;

FIG. 9 is a section view taken from line 9-9 in FIG. 5 showing the reversible socket in a bit holding orientation and position on the drive shank of FIGS. 1 and 2, with the drive shank not shown in section;

FIG. 10 is an end view of another reversible socket shown in FIGS. 1, 3, and 4 that is larger than the socket shown in FIGS. 5-9;

FIG. 11 is a section view taken from line 11-11 in FIG. 10 showing the reversible socket in a pass-through orientation on the drive shank of FIGS. 1 and 2, with the drive shank not shown in section;

FIG. 12A is a section view taken from either of the lines 12-12 in FIG. 10 showing the reversible socket in a nut setting orientation and position on the drive shank of FIGS. 1 and 2;

FIG. 12B is a section view taken from either line 12-12 in FIG. 10 showing the reversible socket in another nut setting orientation and position on the drive shank of FIGS. 1 and 2, but reversed (flipped) from the orientation shown in FIG. 12A;

FIG. 13 is an end view identical to FIG. 5 but with additional section lines shown for the reversible socket of FIG. 5;

FIG. 14 is a section view of the socket of FIGS. 5 and 13 taken from line 7-7 in FIG. 5;

FIG. 15 is a section view of the socket of FIGS. 5 and 13 taken from line 15-15 in FIG. 13;

FIG. 16 is a section view of the socket of FIGS. 5 and 13 taken from line 9-9 in FIG. 5;

FIG. 17 is a section view of the socket of FIGS. 5 and 13 taken from line 17-17 in FIG. 13;

FIG. 18 is a section view of the socket of FIGS. 5 and 13 taken from line 8-8 in FIG. 5;

FIG. 19 is a section view of the socket of FIGS. 5 and 13 taken from line 19-19 in FIG. 13;

FIG. 20 is a view similar to FIG. 15, but showing the reversible socket of FIGS. 5 and 13 “flipped” from the orientation shown in FIG. 15 and mounted on the drive shank in the pass-through orientation of FIG. 7, with the drive shank not shown in section;

FIG. 21 is a view similar to FIG. 17, but showing the reversible socket of FIGS. 5 and 13 “flipped” from the orientation shown in FIG. 17 and mounted on the drive shank in the bit holding orientation of FIG. 9, with the drive shank not shown in section;

FIG. 22 is a view similar to FIG. 19, but showing the reversible socket of FIGS. 5 and 13 “flipped” from the orientation shown in FIG. 19 and mounted on the drive shank in the nut setting orientation of FIG. 8A, with the drive shank not shown in section;

FIG. 23 is a side view of the drive shank of FIGS. 1-4;

FIG. 24 is identical to FIG. 7;

FIG. 25 is view similar to FIGS. 7 and 24, but showing the reversible socket and drive shank of FIGS. 7 and 24 in perspective, with the drive shank shown in section;

FIG. 26 is a view similar to FIG. 25, but with the drive shank not shown;

FIG. 27 is a view similar to FIG. 25, but with the drive shank not shown in section;

FIG. 28 is identical to FIG. 9;

FIG. 29 is view similar to FIGS. 9 and 28, but showing the reversible socket and drive shank of FIGS. 9 and 28 in perspective, with the drive shank shown in section;

FIG. 30 is a view similar to FIG. 29, but with the drive shank not shown;

FIG. 31 is a view similar to FIG. 29, but with the drive shank not shown in section;

FIG. 32A is identical to FIG. 8A;

FIG. 32B is identical to FIG. 8B;

FIG. 33A is view similar to FIGS. 8A and 32A, but showing the reversible socket and drive shank of FIGS. 8A and 32A in perspective, with the drive shank shown in section;

FIG. 33B is view similar to FIGS. 8B and 32B, but showing the reversible socket and drive shank of FIGS. 8B and 32B in perspective, with the drive shank shown in section;

FIG. 34A is a view similar to FIG. 33A, but with the drive shank not shown;

FIG. 34B is a view similar to FIG. 33B, but with the drive shank not shown;

FIG. 35A is a view similar to FIG. 33A, but with the drive shank not shown in section;

FIG. 35B is a view similar to FIG. 33B, but with the drive shank not shown in section;

FIG. 36 is a section view taken from line 11-11 in FIG. 10;

FIG. 37 is a section view taken from line 37-37 in FIG. 10;

FIG. 38 is identical to FIG. 11;

FIG. 39 is view similar to FIGS. 11 and 38, but showing the reversible socket and drive shank of FIGS. 11 and 39 in perspective, with the drive shank shown in section;

FIG. 40 is a view similar to FIG. 39, but with the drive shank not shown;

FIG. 41 is a view similar to FIG. 39, but with the drive shank not shown in section;

FIG. 42 is a section view taken from either line 12-12 in FIG. 10;

FIG. 43 is a section view taken from line 43-43 in FIG. 10;

FIG. 44A is view similar to FIG. 12A, but showing the reversible socket and drive shank of FIG. 12A in perspective, with the drive shank shown in section;

FIG. 44B is view similar to FIG. 12B, but showing the reversible socket and drive shank of FIG. 12B in perspective, with the drive shank shown in section;

FIG. 45A is a view similar to FIG. 44A, but with the drive shank not shown;

FIG. 45B is a view similar to FIG. 44B, but with the drive shank not shown;

FIG. 46A is a view similar to FIG. 44A, but with the drive shank not shown in section; and

FIG. 46B is a view similar to FIG. 44B, but with the drive shank not shown in section.

### DETAILED DESCRIPTION OF PREFERRED EMBODIMENTS

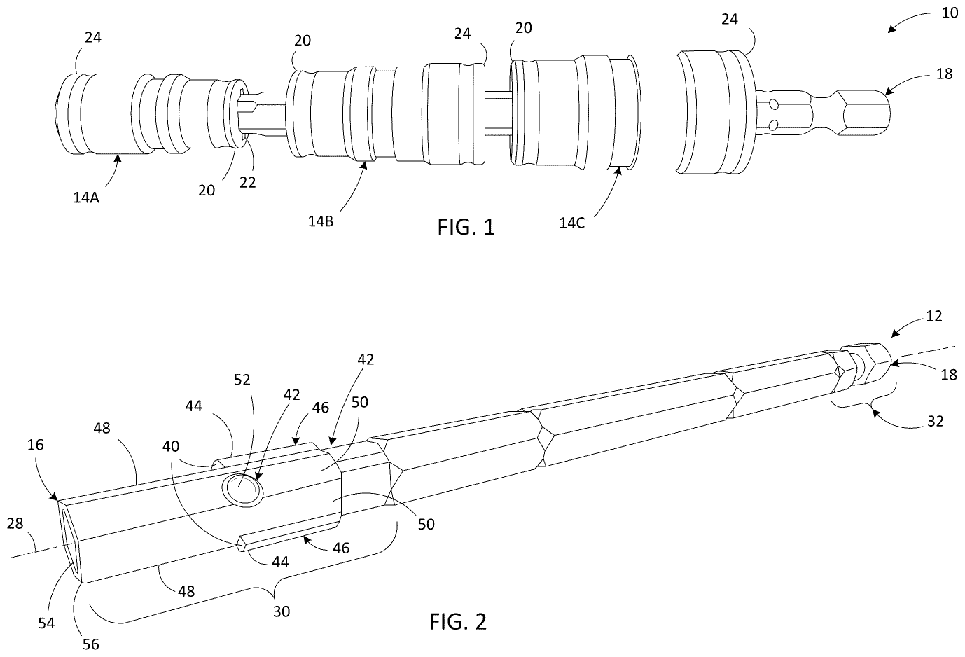

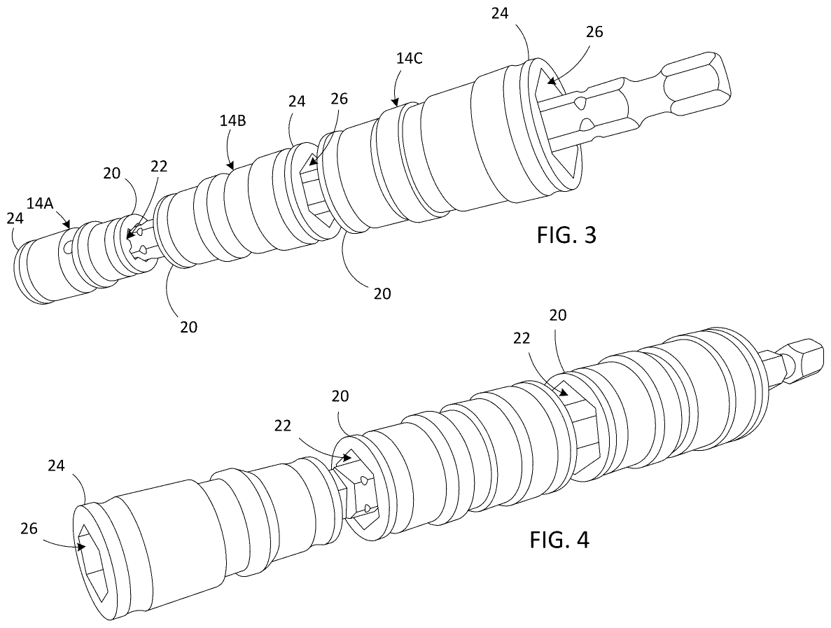

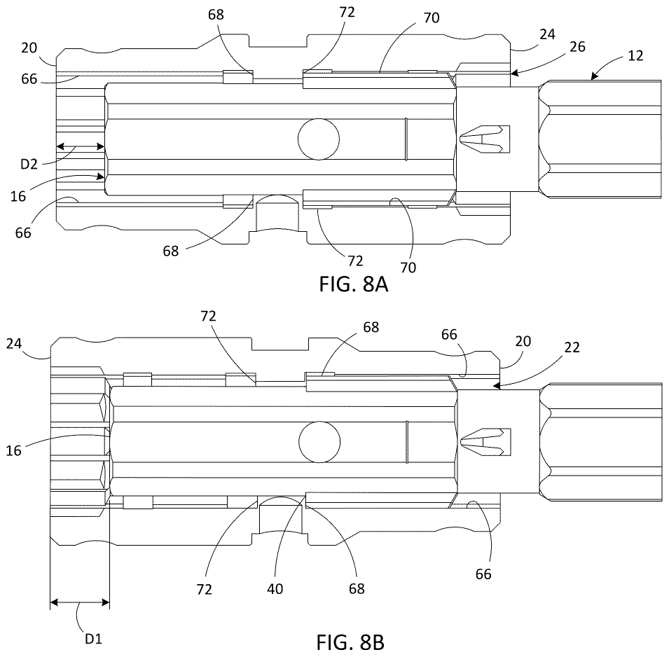

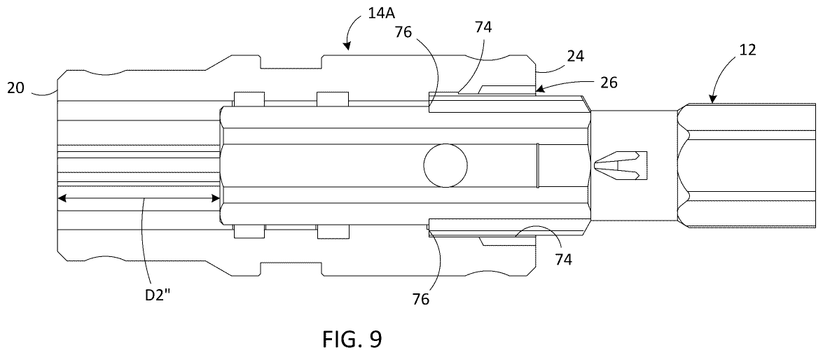

As best seen in FIGS. 1-4, a nut driver 10 includes an elongate drive shank 12 and three reversible sockets 14 (14A, 14B, and 14C). As best seen in FIG. 2, the drive shank 12 has a socket-mounting end 16 opposite a driver engagement end 18. As best seen in FIGS. 3-4, each socket 14 has a first end 20 with a first hex socket opening 22 sized to engage a hexagonal profile of a first size, and a second end 24 with a second hex socket opening 26 sized to engage a hexagonal profile of a second size. For each socket 14, the second size is larger than the first size. In the illustrated and preferred embodiment, for the socket 14A, the first size is 1/4 inch hex socket and the second size is 5/16 inch hex socket. Each of the sockets 14 can be releasably mounted on the drive shank 12 in either a first orientation that presents the first hex socket opening 22 for use or a second orientation that presents the second hex socket opening 26 for use. Additionally, in the first orientation, the socket 14A can be releasably mounted in either a screw head receiving or nut setting position (shallow position), as shown in FIG. 8A, or a drive bit receiving/holding position (deep position), as shown in FIG. 9. In the second orientation, the socket 14A is releasably mounted in a second screw head receiving or nut setting position, as shown in FIG. 8B.

As best seen in FIG. 2, in the illustrated embodiment, the drive shank 12 extends along a longitudinal axis 28 and has uniform, hexagonal shaped cross-sectional profile over the majority of its length. The drive shank 12 has a socket engagement portion 30 extending over a length adjacent the socket-mounting end 16, and a driver engagement portion 32 extending over a length adjacent the driver engagement end 18. The socket engagement portion 30 is configured to provide the releasable mounting of the socket 14 as mentioned above and discussed more fully below. The driver engagement portion 32 is configured to allow a drive member (such as the type of handle commonly employed on a screw or nut driver, or any common bit chuck used on a powered driver tool, or a quick release chuck on an impact driver tool) to operably engage the shank 12 to transmit a drive torque to the sockets 14 via the shank 12.

As best seen in FIG. 2, the socket engagement portion 30 includes 2 socket stop surfaces 40 facing the socket-mounting end 16 and a spring-biased ball detent 42 located near the socket stop surfaces 40. In the illustrated and preferred embodiment, each of the stop surfaces 40 is defined on an end 44 of a corresponding elongate rib 46, with each of the ribs 46 extending along an intersection 48 of two planar surfaces 50 of the shank 12. It should be understood that there are six planar surfaces 50 and six intersections 48 that define the hexagonal shaped cross-sectional profile of the drive shank 12 and that the ribs 46 and associated stop surfaces are located 180 degrees from each other. As best seen in FIG. 2, in the illustrated and preferred embodiment, the detent 42 extends outwardly from one of the surfaces 50 and the detent 42 is preferably a spring biased ball detent received in a bore 52 that is transverse to the axis 28. In some embodiments, there are two of the detents 42 located 180 degrees from each other and 90 degrees from the ribs 46. In illustrated embodiment, the shank 12 further includes a magnet 54 defining the socket-mounting end 16, with the magnet fixed in a bore 56 centered on the axis 28.

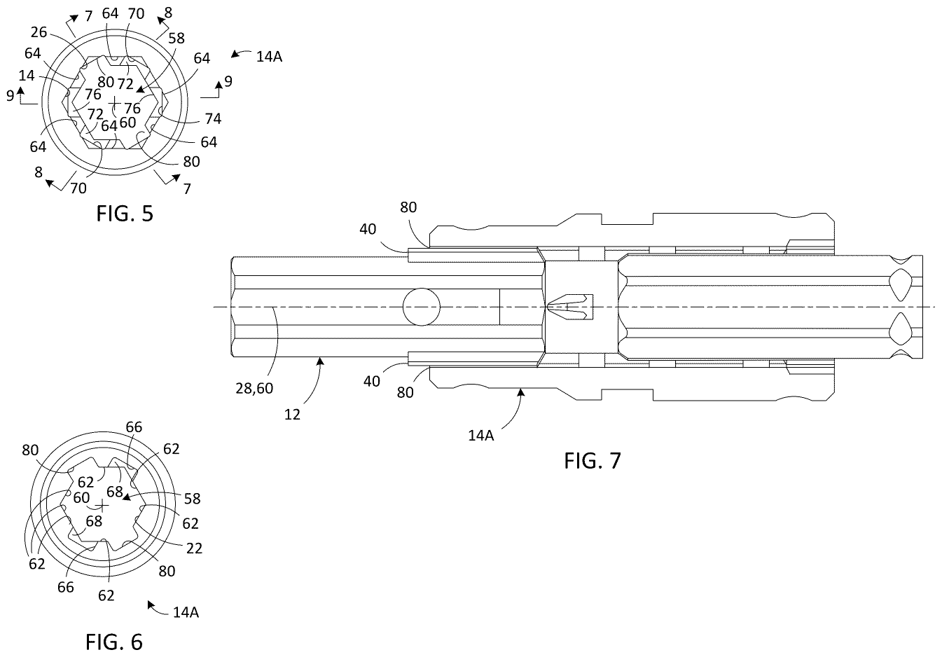

As best seen in FIGS. 5-9, the illustrated socket 14A includes a through opening 58 connecting the first and second hex socket openings 22 and 26, with all three openings 22, 26, and 58 being centered on a longitudinal axis 60 that is coaxial with the axis 28 when the socket 14 is mounted on the shank 12. As best seen in FIGS. 5 and 6, in the illustrated embodiments each of the openings 22, 26, and 58 have a hexagonal shape defined by inwardly facing planar surfaces, with six inwardly facing planar surfaces 62 defining the hexagonal shape of the openings 22 and 58 and six inwardly facing planar surfaces 64 defining the hexagonal shape of the opening 26. It should be appreciated that because the planar surfaces 62 define the hexagonal shape for both the opening 22 and the through opening 58 in the illustrated embodiments, the through opening 58 also provides a ¼ inch hex socket size that serves as an extension of the ¼ inch hex socket of the opening 22.

A pair of linear grooves or channels 66 extend parallel to the axis 60 at intersections of the planar surfaces 62 in the opening 22, with each channel 66 extending from the first end 20 to a corresponding stop surface 68 facing the first end 20. In the illustrated and preferred embodiment, the channels 66 are located opposite each other in the opening 22 such that they are spaced apart by an angular distance of 180 degrees. It follows that the stop surfaces are also spaced apart by the angular distance of 180 degrees.

The illustrated socket 14 further includes a pair of linear grooves or channels 70 extending parallel to the axis 60 at intersections of the planar surfaces 64 in the opening 26, with each channel 70 extending from the second end 24 to a corresponding stop surfaces 72 facing the second end 24. The channels 70 are located opposite each other in the opening 26 such that they are spaced apart by an angular distance of 180 degrees. It follows that the stop surfaces 72 are spaced apart by the angular distance of 180 degrees. An additional pair of linear grooves or channels 74 extend parallel to the axis 60 at intersections of the planar surfaces 64 in the opening 26, with each channel 74 extending from the second end 24 to a corresponding stop surface 76 facing the second end 24. The channels 74 are located opposite each other in the opening 26 such that they are spaced apart by an angular distance of 180 degrees. It follows that the stop surfaces 76 are spaced apart by the angular distance of 180 degrees. In the illustrated and preferred embodiment, the stop surfaces 68 are located a first distance from the first end, the stop surfaces 72 are located a second distance from the second end, and the stop surfaces 76 are located a second additional distance from the second end, with the second additional distance being less than the second distance.

As best seen in FIG. 8B, the first channels 66 are sized to allow the socket stop surfaces to translate within the first channels 66 from the first end 20 to engaged against the stop surfaces 68 to mount the reversible socket 14A on the socket-mounting end 16 in a first position wherein the drive shank 12 extends through the firs hex socket opening 22 with the socket-mounting end 16 spaced from the second end 24 by a first predetermined distance D1. As best seen in FIG. 8A, the second channels 70 are sized to allow the socket stop surfaces 40 to translate within the second channels 70 from the second end 24 to engage against the second stop surfaces 72 to mount the reversible socket 14A on the socket-mounting end 16 in a second position wherein the drive shank 12 extends through the second hex socket opening 26 with the socket-mounting end 16 spaced from the first end 20 by a second predetermined distance D2. As best seen in FIG. 9, the second additional channels 74 are sized to allow the socket stop surfaces 40 to translate within the second additional channels 74 from the second end 24 to engage against the second additional stop surfaces 76 to mount the reversible socket 14A on the socket-mounting end 16 in a second additional position wherein the drive shank 12 extends through the second hex socket opening 26 with the socket-mounting end 16 spaced from the first end 20 be a second additional predetermined distance D2″. In the preferred and illustrated embodiments of socket 14A, the second additional predetermined distance D2″ is greater than the second predetermined distance, preferably with the second additional predetermined distance D2″ being at least twice the second predetermined distance D2. In the preferred and illustrated embodiment, the second position is a nut driving position with D2 being a distance appropriate to drive a hex nut or a hex head on a threaded fastener to be received in and driven by the first hex opening 24, and the second additional position is a bit receiving position with D2″ being a distance appropriate for a standard sized driver bit to be received in the first hex opening 24 and retained therein by the magnet 54.

As best seen in FIG. 5-7, the socket 14A further includes yet another pair of channels 80, with each channel 80 extending from the first end 20 to the second end 24 and spaced circumferentially from the channels 66, 70, and 74. The channels 80 are located opposite each other in the opening 58 such that they are spaced apart by the same angular distance used to space the other pairs of channels, 180 degrees. As best seen in FIG. 7, the channels 80 are sized to allow the socket stop surfaces 40 to translate within the channels 80 to allow the reversible socket 14A to be translated past the socket-mounting end 16 from a stored position on the shank located between the socket-mounting end 16 and the driver engagement end 18.

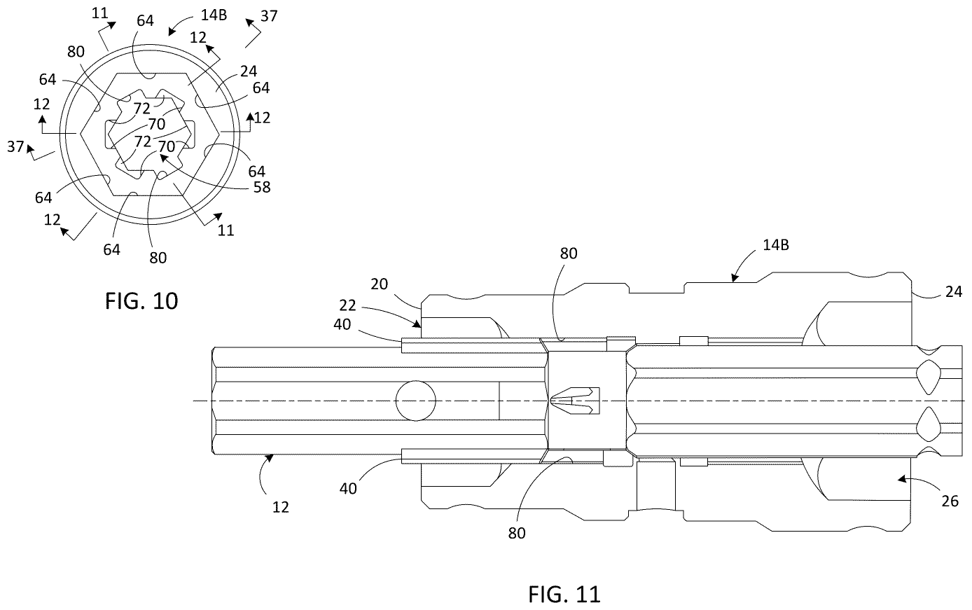

As best seen in FIGS. 10-12B, like the socket 14A, the socket 14B includes a through opening 58 connecting the first and second hex socket openings 22 and 26, with all three openings 22, 26, and 58 being centered on a longitudinal axis 60 that is coaxial with the axis 28 when the socket 14B is mounted on the shank 12. Again, like the socket 14A, in the illustrated embodiments each of the openings 22, 26, and 58 of the socket 14B have a hexagonal shape defined by inwardly facing planar surfaces, with six inwardly facing planar surfaces 62 defining the hexagonal shape of the openings 22 and 58 and six inwardly facing planar surfaces 64 defining the hexagonal shape of the opening 26.

Again as best seen in FIGS. 10-12B, the socket 14B differs from the socket 14A in that the socket 14B includes two pairs of the linear channels 66 rather than just one pair. As with the socket 14A, the channels 66 in socket 14B extend parallel to the axis 60 at intersections of the planar surfaces 62 in the opening 22, with each channel 66 extending from the first end 20 to a corresponding stop surface 68 facing the first end 20. The channels 66 of each pair are located opposite each other in the opening 22 such that they are spaced apart by an angular distance of 180 degrees. It follows that the stop surfaces are also spaced apart by the angular distance of 180 degrees.

As best seen again in FIGS. 10-12B, the socket 14B differs from the socket 14A in that the socket 14B includes two pairs of the channels 70 rather than just one pair. As with the socket 14A, the channels 70 in socket 14B extending parallel to the axis 60 at intersections of the planar surfaces 64 in the opening 26, with each channel 70 extending from the second end 24 to a corresponding stop surfaces 72 facing the second end 24. The channels 70 of each pair are located opposite each other in the opening 26 such that they are spaced apart by an angular distance of 180 degrees. It follows that the stop surfaces 72 are spaced apart by the angular distance of 180 degrees.

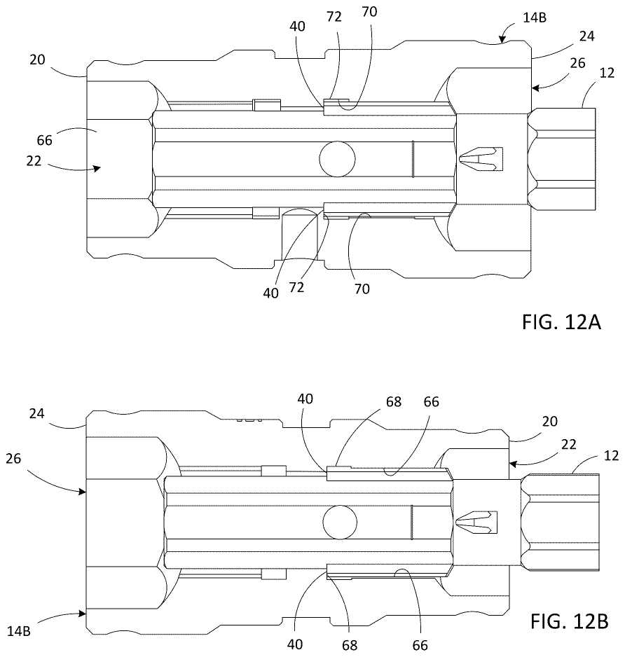

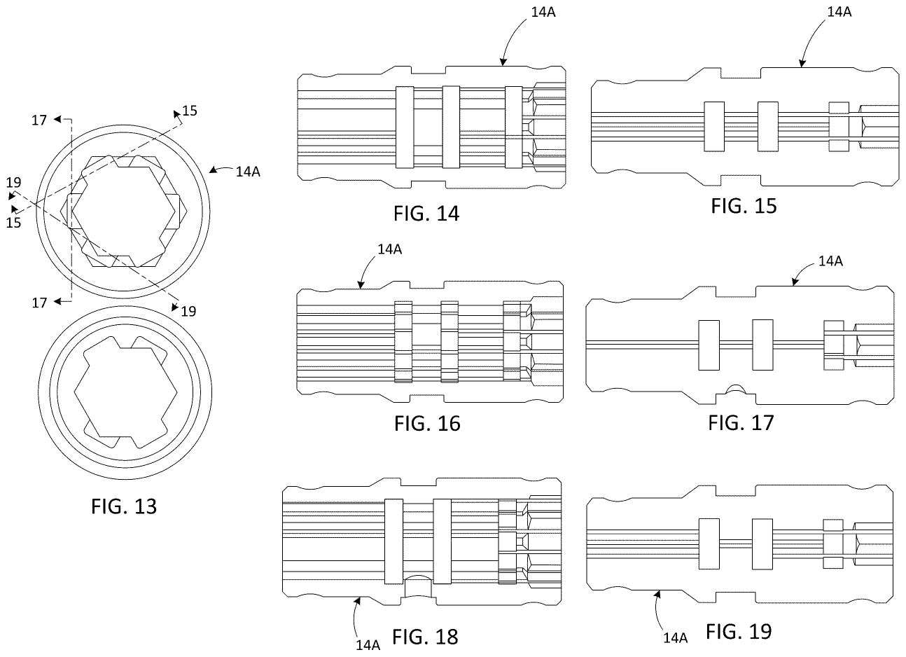

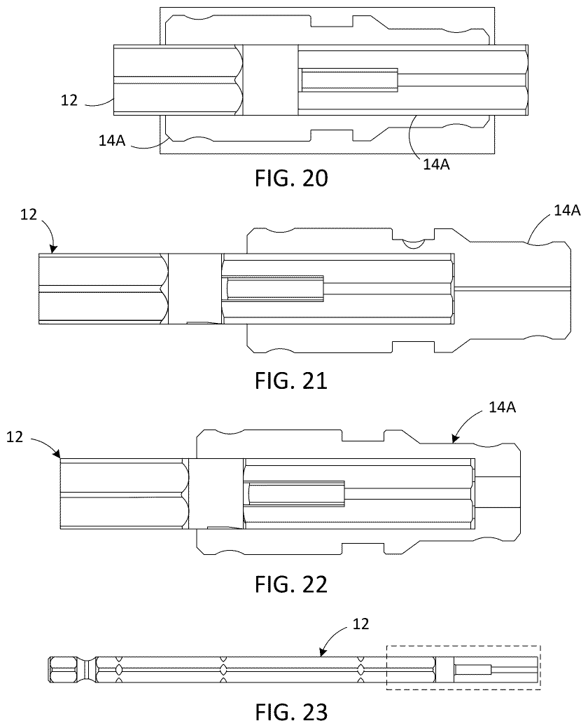

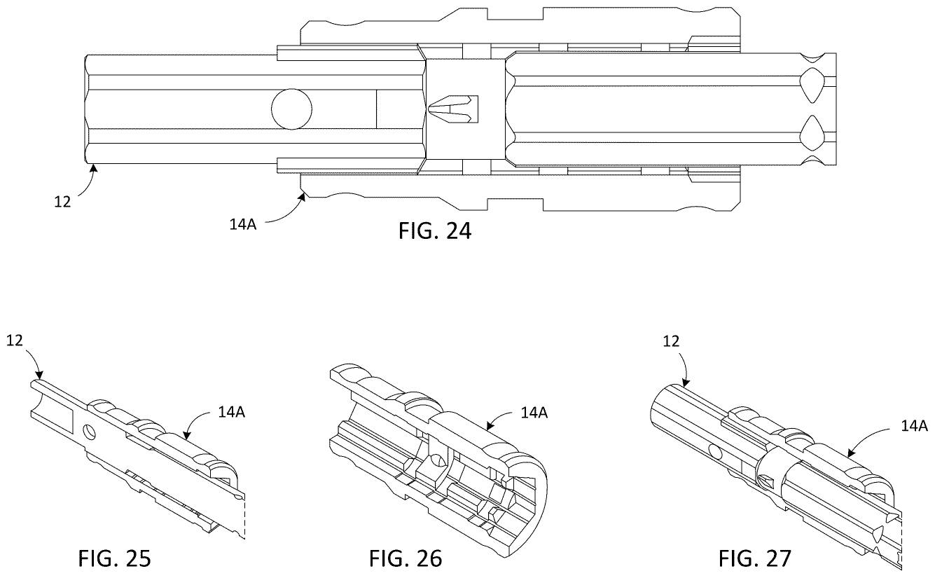

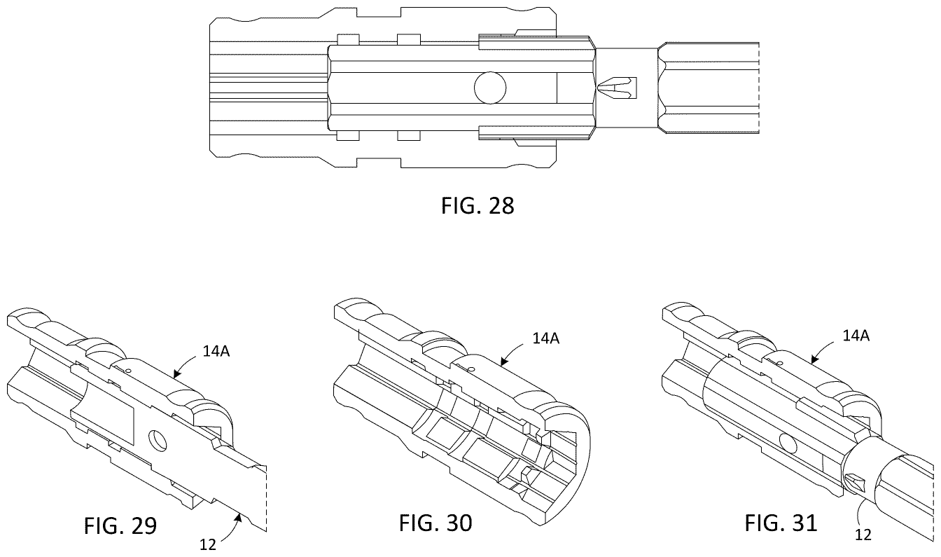

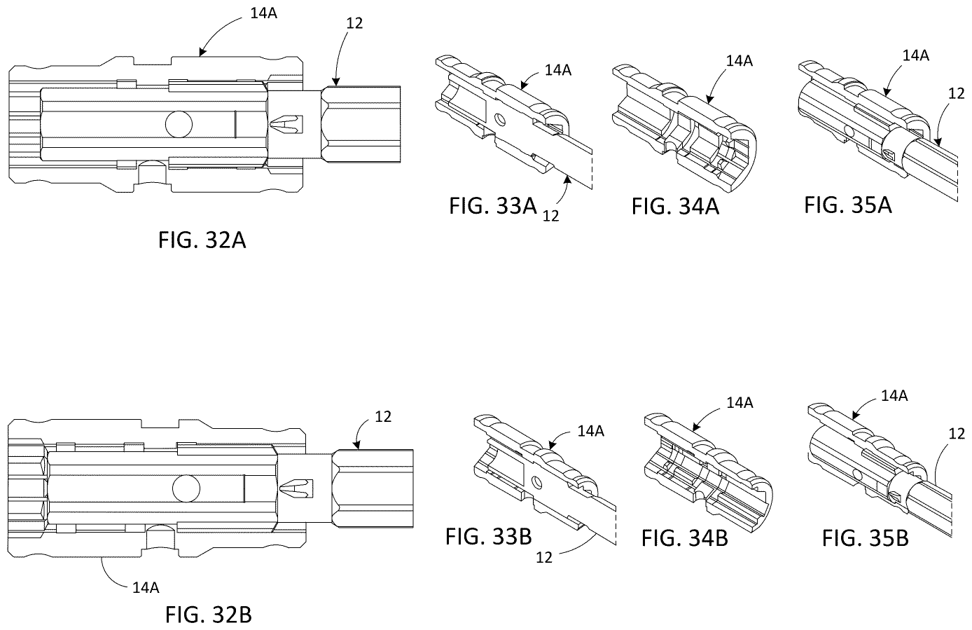

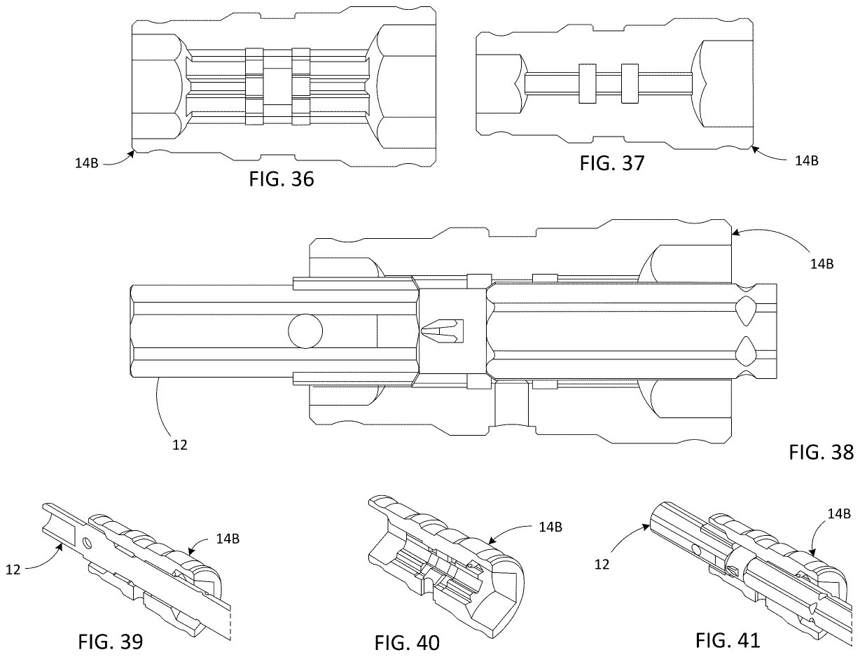

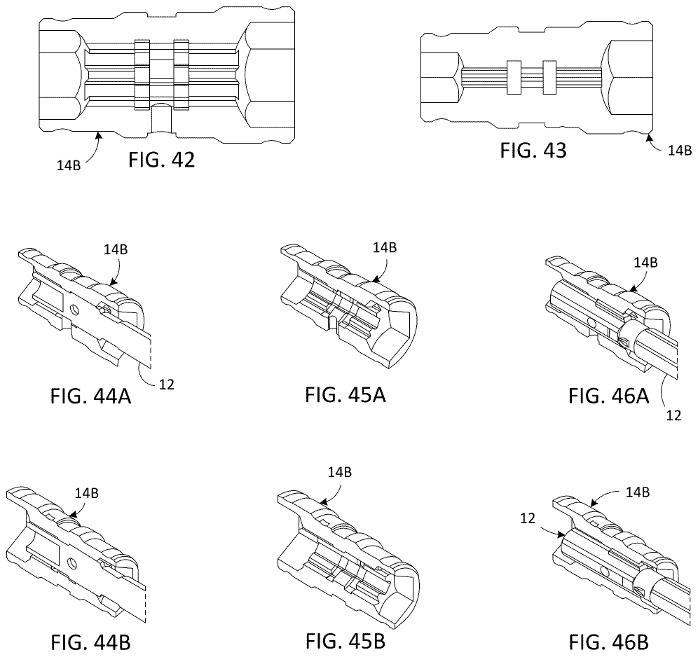

As best seen in FIG. 12B, the first channels 66 are sized to allow the socket stop surfaces 40 to translate within the first channels 66 from the first end 20 to engaged against the stop surfaces 68 to mount the reversible socket 14B on the socket-mounting end 16 in a first position wherein the drive shank 12 extends through the first hex socket opening 22 with the socket-mounting end 16 spaced from the second end 24 by a predetermined distance. As best seen in FIG. 12A, the channels 70 are sized to allow the socket stop surfaces 40 to translate within the channels 70 from the second end 24 to engage against the second stop surfaces 72 to mount the reversible socket 14B on the socket-mounting end 16 in a second position wherein the drive shank 12 extends through the second hex socket opening 26 with the socket-mounting end 16 spaced from the first end 20 by a second predetermined distance.

As best seen in FIGS. 10 and 11, like the socket 14A, the socket 14B further includes yet another pair of channels 80, with each channel 80 extending from the first end 20 to the second end 24 and spaced circumferentially from the channels 66, and 70. The channels 80 are located opposite each other in the opening 58 such that they are spaced apart by the same angular distance used to space the other pairs of channels, 180 degrees. As best seen in FIG. 11, the channels 80 are sized to allow the socket stop surfaces 40 to translate within the channels 80 to allow the reversible socket 14B to be translated past the socket-mounting end 16 from a stored position on the shank located between the socket-mounting end 16 and the driver engagement end 18.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are hereby incorporated by reference to the same extent as if each reference were individually and specifically indicated to be incorporated by reference and were set forth in its entirety herein.

What is claimed is:

1. A nut driver tool comprising:
an elongate drive shank including:
a socket-mounting end opposite a driver engagement end; and
a pair of socket stop surfaces facing the socket-mounting end and spaced from the socket-mounting end, the socket stop surfaces spaced from each other by an angular distance; and
a reversible socket including:
a first end opposite a second end;
a first hex socket opening in the first end and sized to engage a hexagonal profile of a first size;
a second hex socket opening in the second end and sized to engage a hexagonal profile of a second size larger than the first size, the second hex socket facing in an opposite direction from the first hex socket opening;
a through opening connecting the first and second hex socket openings,
a pair of first stop surfaces facing the first end, the first stop surfaces spaced from each other by the angular distance;
a pair of first channels, each of the first channels extending from the first end to a corresponding one of the first stop surfaces, the first channels spaced from each other by the angular distance;
a pair of second stop surfaces facing the second end, the second stop surfaces spaced from each other by the angular distance;
a pair of second channels, each second channel extending from the second end to a corresponding one of the second stop surfaces, the second channels spaced from each other by the angular distance; and
a pair of third channels, each third channel extending from the first end to the second end and spaced circumstantially from the first and second channels, the third channels spaced from each other by the angular distance; and
wherein:
the first channels are sized to allow the socket stop surfaces to translate within the first channels from the first end to engage against the first stop surfaces to mount the reversible socket on the socket-mounting end in a first position wherein the drive shank extends through the first hex socket opening with the socket-mounting end spaced from the second end by a first predetermined distance;
the second channels are sized to allow the socket stop surfaces to translate within the second channels from the second end to engage against the second stop surfaces to mount the reversible socket on the socket-mounting end in a second position wherein the drive shank extends through the second hex socket opening with the socket-mounting end spaced from the first end by a second predetermined distance; and
the third channels are sized to allow the socket stop surfaces to translate within the third channels to allow the reversible socket to be translated past the socket-mounting end from a stored position on the shank located between the socket-mounting end and the driver engagement end.

2. The tool of claim 1 wherein:
the drive shank further comprises a detent located on the socket-mounting; and the reversible socket further comprises:
a first detent engagement feature located between the first end and the pair of first stop surfaces, the first detent engagement feature being configured to engage the detent with the socket in the first position; and
a second detent engagement feature located between the second end and the pair of second stop surfaces, the second detent engagement feature being configured to engage the detent with the socket in the second position.

3. The tool of claim 1 wherein the reversible socket further comprises
a pair of second additional stop surfaces facing the second end, the second additional stop surfaces spaced from each other by the angular distance; and
a pair of second additional channels, each second additional channel extending from the second end to a corresponding one of the second additional stop surfaces, the second additional channels spaced from each other by the angular distance; and wherein
the second additional channels are sized to allow the socket stop surfaces to translate within the second additional channels from the second end to engage against the second additional stop surfaces to mount the reversible socket on the socket-mounting end in a second additional position wherein the drive shank extends through the second hex socket opening with the socket-mounting end spaced from the first end by a second additional predetermined distance.

4. The tool of claim 3 wherein the second predetermined distance and the second additional predetermined distance are equal.

5. The tool of claim 3 wherein the second additional predetermined distance is greater than the second predetermined distance.

6. The tool of claim 5 wherein the second additional predetermined distance is at least twice the second predetermined distance.

7. The tool of claim 3 wherein the reversible socket further comprises:
a pair of first additional stop surfaces facing the first end, the first additional stop surfaces spaced from each other by the angular distance; and
a pair of first additional channels, each first additional channel extending from the first end to a corresponding one of the additional stop surfaces, the first additional channels spaced from each other by the angular distance; and wherein
the first additional channels are sized to allow the socket stop surfaces to translate within the first additional channels from the first end to engage against the first additional stop surfaces to mount the reversible socket on the socket-mounting end in a first additional position wherein the drive shank extends through the first hex socket opening with the socket-mounting end spaced from the second end by a first additional predetermined distance; and
the first predetermined distance and the first additional predetermined distance are equal.

8. The tool of claim 3 wherein:
the drive shank further comprises a detent located on the socket-mounting end; and
the reversible socket further comprises:
a first detent engagement feature located between the first end and the pair of first stop surfaces, the first detent engagement feature being configured to engage the detent with the socket in the first position;
a second detent engagement feature located between the second end and the pair of second stop surfaces, the second detent engagement feature being configured to engage the detent with the socket in the second position; and
a second additional detent engagement feature located between the second end and the pair of second additional stop surfaces, the second additional detent engagement feature being configured to engage the detent with the socket in the second additional position.

9. The tool of claim 8 wherein the second predetermined distance and the second additional predetermined distance are equal.

10. The tool of claim 9 wherein the second additional predetermined distance is greater than the second predetermined distance.

11. The tool of claim 10 wherein the second additional predetermined distance is at least twice the second predetermined distance.

12. The tool of claim 1 wherein:
the through opening has a hexagonal shaped cross-section sized to engage a hexagonal profile; and
the shank has a socket engagement portion extending over a length of the socket-mounting end, the socket engagement portion having a hexagonal profile sized to engage the hexagonal profile of the through opening.

13. The tool of claim 12 wherein the shank has a driver engagement portion extending over a length of the driver engagement end, the driver engagement portion having a hexagonal profile of the same size as the socket engagement portion.

14. The tool of claim 1 wherein the shank includes a pair of elongated ribs, each rib having an end that defines one of the socket stop surfaces.

15. The tool of claim 14 wherein each of the ribs extends along an intersection of two planar surfaces of the shank and the angular distance equals 180 degrees.

16. A nut driver tool comprising:
an elongate drive shank including:
a socket-mounting end opposite a driver engagement end; and
a pair of socket stop surfaces facing the socket-mounting end and spaced from the socket-mounting end, the socket stop surfaces spaced from each other by an angular distance; and
at least two reversible sockets, each reversible socket including:
a first end opposite a second end;
a first hex socket opening in the first end and sized to engage a hexagonal profile of a first size;
a second hex socket opening in the second end and sized to engage a hexagonal profile of a second size larger than the first size, the second hex socket facing in an opposite direction from the first hex socket opening;
a through opening connecting the first and second hex socket openings,
a pair of first stop surfaces facing the first end, the first stop surfaces spaced from each other by the angular distance;
a pair of first channels, each of the first channels extending from the first end to a corresponding one of the first stop surfaces, the first channels spaced from each other by the angular distance;
a pair of second stop surfaces facing the second end, the second stop surfaces spaced from each other by the angular distance;
a pair of second channels, each second channel extending from the second end to a corresponding one of the second stop surfaces, the second channels spaced from each other by the angular distance; and
a pair of third channels, each third channel extending from the first end to the second end and spaced circumstantially from the first and second channels, the third channels spaced from each other by the angular distance; and
wherein:
the first channels are sized to allow the socket stop surfaces to translate within the first channels from the first end to engage against the first stop surfaces to mount the reversible socket on the socket-mounting end in a first position wherein the drive shank extends through the first hex socket opening with the socket-mounting end spaced from the second end by a first predetermined distance;
the second channels are sized to allow the socket stop surfaces to translate within the second channels from the second end to engage against the second stop surfaces to mount the reversible socket on the socket-mounting end in a second position wherein the drive shank extends through the second hex socket opening with the socket-mounting end spaced from the first end by a second predetermined distance; and
the third channels are sized to allow the socket stop surfaces to translate within the third channels to allow the reversible socket to be translated past the socket-mounting end from a stored position on the shank located between the socket-mounting end and the driver engagement end.

17. The nut driver tool of claim 16 wherein each of the hex socket openings is sized to engage a hexagonal profile of a size that is different than any of the other hex socket openings.

18. The tool of claim 17 wherein each of the reversible sockets further comprises:
a pair of first additional stop surfaces facing the first end, the first additional stop surfaces spaced from each other by the angular distance;
a pair of first additional channels, each first additional channel extending from the first end to a corresponding one of the additional stop surfaces, the first additional channels spaced from each other by the angular distance;
a pair of second additional stop surfaces facing the second end, the second additional stop surfaces spaced from each other by the angular distance; and
a pair of second additional channels, each second additional channel extending from the second end to a corresponding one of the second additional stop surfaces, the second additional channels spaced from each other by the angular distance; and wherein
the first additional channels are sized to allow the socket stop surfaces to translate within the first additional channels from the first end to engage against the first additional stop surfaces to mount the reversible socket on the socket-mounting end in a first additional position wherein the drive shank extends through the first hex socket opening with the socket-mounting end spaced from the second end by a first additional predetermined distance; and
the second additional channels are sized to allow the socket stop surfaces to translate within the second additional channels from the second end to engage against the second additional stop surfaces to mount the reversible socket on the socket-mounting end in a second additional position wherein the drive shank extends through the second hex socket opening with the socket-mounting end spaced from the first end by a second additional predetermined distance.

19. The tool of claim 18 where, for at least one of the reversible sockets, the first predetermined distance and the first additional predetermined distance are equal, and the second predetermined distance and the second additional predetermined distance are equal.

20. The tool of claim 16 wherein at least one of the reversible sockets further comprises:
a pair of second additional stop surfaces facing the second end, the second additional stop surfaces spaced from each other by the angular distance; and
a pair of second additional channels, each second additional channel extending from the second end to a corresponding one of the second additional stop surfaces, the second additional channels spaced from each other by the angular distance; and wherein
the second additional channels are sized to allow the socket stop surfaces to translate within the second additional channels from the second end to engage against the second additional stop surfaces to mount the reversible socket on the socket-mounting end in a second additional position wherein the drive shank extends through the second hex socket opening with the socket-mounting end spaced from the first end by a second additional predetermined distance; and
the second additional predetermined distance is greater than the second predetermined distance.
